(19) United States
(12) Patent Application Publication
(10) Pub. No.: US 2008/0090071 A1
(43) Pub. Date: Apr. 17, 2008

(54) Nanosturctured Coating and Coating Method

(75) Inventors: Karine Valle, Tours (FR); Philippe Belleville, Tours (FR); Karine Wittmann-Teneze, Chambray-Les-Tours (FR); Luc Bianchi, Artannes Sur Indre (FR); Franck Blein, St Avertin (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT A L'ENERGIE ATOMIQUE, PARIS (FR)

(21) Appl. No.: 11/577,257

(22) PCT Filed: Oct. 20, 2005
(86) PCT No.: PCT/FR05/50870

§ 371 Date: Apr. 13, 2007

(30) Foreign Application Priority Data
Oct. 21, 2004 (FR) 0452390

(51) Int. Cl. C23C 4/04; B32B 5/16

(52) U.S. Cl. 428/336; 118/723 R; 427/446; 427/447; 427/452; 427/453; 427/455; 427/456; 428/332; 977/773

(57) ABSTRACT

The present invention relates to a method of coating a surface with nanoparticles, to a nanostructured coating that can be obtained by this method, and also to a device for implementing the method of the invention. The method is characterized in that it comprises an injection of a colloidal sol of said nanoparticles into a plasma jet that sprays them onto said surface. The device (1) comprises: a plasma torch (3); at least one container (5) containing the colloidal sol (7) of nanoparticles; a device (9) for fixing and for moving the substrate(S); and a device (11) for injecting the colloidal sol into the plasma jet (13) of the plasma torch. The present invention has applications in optical, electronic and energy devices (cells, thermal barriers) comprising a nanostructured coating that can be obtained by the method of the invention.

### TECHNICAL FIELD

The present invention relates to a method of coating a surface of a substrate with nanoparticles, to a nanostructured coating that can be obtained by this method, and also to a device for implementing the method of the invention.

The present invention also relates to optical, mechanical, chemical, electronic and energy devices comprising a nanostructured coating that can be obtainable by the method of the invention.

Nanostructured materials are defined as materials organized on a nanoscale, that is to say a scale ranging from a few nm to a few hundred nm. This size range is that corresponding to the characteristic lengths of various physical, electronic, magnetic, optical, superconductivity, mechanical or other processes, and where the surface plays a predominant role in these processes, thereby giving these “nanomaterials” specific and often enhanced properties. Owing to these characteristics, such materials truly have a great potential for the construction of novel high-performance structures exhibiting specific properties.

The possibility of manufacturing nanostructures allows innovative materials to be developed and offers the possibility of exploiting them in many fields, such as in optics, in electronics, in the energy field, etc. These nanomaterials have undeniable fundamental spin-off uses and important applications and potential applications in various technologies in the future, such as in fuel cells, “smart” coatings, and resistant (thermal barrier) materials.

The present invention allows the development of novel nanostructured coatings by a simple and easily industrializable method and opens these technologies to industrial concerns. The essence of the “nano” concept is auto-assembly, which leads complex molecules to form larger heterogeneous aggregates capable of fulfilling a sophisticated function or of constituting a material having unprecedented properties.

The references between square brackets ([]) refer to the list of literature references given after the examples.

Prior Art

Hitherto there have not existed techniques that are simple to implement and allow nanoparticle coatings to be obtained that meet the ever increasing requirements of structural and thickness homogeneity, even on the scale of a few microns, and of mechanical strength, owing to the miniaturization of electromechanical and/or optical and/or electrochemical microsystems.

The inventors of the present invention were interested in plasma spraying. This is a technique used in the research laboratory and in industry for depositing coatings consisting of ceramics, metals or cermets, or polymers and also combinations of these materials, on various types of substrates (differing in form and nature). Its principle is the following: the material to be deposited is injected in dry form into the plasma jet in the form of particles, the mean diameter of which is generally greater than 5 μm, using a carrier gas. In this medium, the particles are completely or partially melted and accelerated towards a substrate where they stack up.

However, the layer thus formed, having a thickness generally greater than 100 μm, possesses a highly anisotropic lamellar structure characteristic of coatings deposited by plasma spraying. These techniques therefore do not allow coatings consisting of nanoparticles to be formed, nor coatings having thicknesses of less than 100 μm going down to a few microns.

In addition, the coatings obtained have the drawback of being microcracked, especially in the case of depositing ceramics, which brittle materials thus relax the internal stresses.

Furthermore, it has been found that the coating obtained has a lamellar structure that greatly determines its thermomechanical properties. This therefore clearly limits, right from the outset, the potential applications of plasma spraying.

In particular, the emergence of novel applications, especially in microelectronics and laboratory-on-a-chip applications, requires coatings to be deposited with a thickness of less than 50 μm, consisting of submicron-sized grains necessarily not having a lamellar structure, and using high deposition rates. However, it is not currently possible to make particles with a diameter of less than 1 micron penetrate into a plasma jet using a conventional carrier-gas injector without considerably disturbing the plasma jet. This is because the high velocity of the cold carrier gas, needed to accelerate fine particles, results in a substantial reduction in the temperature and the flow velocity of the plasma, which are essential properties for melting and entraining the particles.

Various solutions have been proposed. Thus, document [1] by Lau et al. describes the use of an aqueous solution, consisting of at least three metal salts, which is atomized in a subsonic inductively coupled plasma. This results in superconducting ceramics being deposited, but these do not have a nanoscale structure.

Document [2] by Marantz et al. describes the axial injection of a colloidal solution into a transferred-arc plasma. Deposition of nanostructured coatings is neither mentioned nor suggested. In addition, this method is difficult to carry out on an industrial scale as it requires the use of two to four plasma torches operating simultaneously.

Document [3] by Ellis et al. describes a method in which an organometallic compound in gaseous or solid form is introduced into a subsonic inductively coupled plasma. However, the coating formed does not have a nanoscale structure.

In document [4], Gitzhofer et al. describe the use of a liquid laden with particles having a size of the order of one micron. This liquid is injected into a plasma in the form of droplets by means of an atomizer. This technique is limited to radiofrequency plasmas and the resulting deposited coatings are not nanostructured.

In document [5], Chow et al. describe a method consisting in injecting several solutions into a plasma jet so as to deposit coatings possessing a nanoscale structure. However, the final material derives from a chemical reaction in flight within the plasma, making the method complicated to control. Furthermore, in this method (which employs a chemical reaction in the plasma) the size of the particles is 100 nm. The method nominally entails a chemical conversion during the spraying process and uses dispersants. Furthermore, the spraying conditions are chosen explicitly so as not to vaporize the solvent of the sprayed solution before it reaches the substrate.

In document [6], Kear et al. propose injecting a solution containing agglomerates of nanostructured powders in the form of a spray into a plasma. The use of a spray imposes various steps so that the size of the particles to be injected is sufficiently small (of the order of one micron) to penetrate into the plasma: the solution containing small particles must be dried, these particles must be agglomerated using a binder, and the agglomerates of size greater than 1 micron must be put into colloidal suspension. This method requires the assistance of ultrasound or the use of dispersants, for example surfactants, in order to keep the suspended particles dispersed in the liquid.

Document [7] by Rao N. P. et al. describes a method in which gaseous precursors, injected radially into an arc plasma, give rise to the formation of solid particles in flight by nucleation/growth. However, the thickness of the coatings deposited cannot exceed around ten microns and it is not possible to produce any type of material.

The problems associated with the plasma technique are therefore very numerous, as are also the solutions proposed, but none of the above solutions presently allows all of these problems to be solved.

The inventors were also interested in existing sol-gel deposition processes, especially in the field of optics. These processes conventionally use liquid deposition methods such as spin coating, meniscus coating, dip coating and spray coating. These various techniques result in thin layers having a thickness generally less than one micron. Some of these deposition processes allow large areas to be coated, for example measuring a few hundred cm² to several m², this being an advantage.

However, the coatings obtained by these processes crack above critical thicknesses of the order of one micron. The main cause of this major drawback lies in the tensile stresses applied by the substrate during the heat treatments needed to produce them. Another disadvantage lies in the impossibility of depositing homogeneous coatings have good adhesion, even for thicknesses of greater than about 150 nm.

The problems associated with this other technique are therefore also very numerous, even though recent techniques have allowed some of them to be solved by acting on the sol-gel chemical composition.

To summarize, none of the above techniques of the prior art allows a nanoparticle coating of homogeneous thickness and a structure to be obtained and none of these techniques suggests a promising way of simple achieving it.

### SUMMARY OF THE INVENTION

One goal of the present invention is specifically to provide a method for forming a nanostructured coating that meets the requirements indicated above and offers a solution to all of the aforementioned drawbacks.

Another goal of the present invention is to provide a nanoparticle coating that does not have the drawbacks, defects and disadvantages of the coatings of the prior art and can be used in optical, mechanical, chemical, electronic and energy devices and microsystems, present and future ones, while exhibiting excellent performance characteristics.

Another goal of the present invention is to provide an example of a device that allows the method of the present invention to be implemented.

The method of the invention is a method of coating a surface of a substrate with nanoparticles, characterized in that it comprises an injection of a colloidal sol of said nanoparticles into a thermal plasma jet that sprays (impinges) them onto said surface.

the inventors are the first to solve the aforementioned drawbacks of the prior art relating to plasma deposition using this method. Compared with the prior techniques, it consists in particular in replacing the dry injection gas with a carrier liquid consisting of a colloidal sol. The sprayed particles are thus stabilized in a liquid medium before being accelerated in a plasma.

As explained above, more recent studies have already been carried out on the injection of a material in a form other than powder form into a plasma, and especially in liquid form. However, none of these studies either uses or suggests directly injecting a colloidal sol, or a colloidal sol-gel solution, into a plasma jet, nor the possibility of depositing nanostructured coatings of any type of material possessing the same chemical and structural composition as the initial product.

The method of the present invention furthermore makes it possible, unexpectedly, to maintain the nanostructural properties of the sprayed material thanks to the thermal spraying of a stabilized suspension (sol) of nanoscale particles. The method of the invention makes ti possible to dispense with stabilizing additives, such as dispersants or surfactants as in the methods of the prior art, and/or the essential use of ancillary dispersion means, such as ultrasound, atomization, mechanical stirring, etc. during the spraying phase. The present invention consequently makes it possible both to maintain the purity of the sprayed material and to simplify the method of implementation. It is also in particular thanks to the use of a sol that the aggregation of nanoparticles is limited and that the method of the invention results in a homogeneous nanostructured coating.

In addition, thanks to the method of the present invention, the inventors exploit the singular advantage of sol-gels of offering very many physicochemical ways of obtaining stable nanoparticulate colloidal suspension. The “gentle” chemistry involved in making up sol-gels makes it possible in particular to synthesize, from very many inorganic or organometallic precursors, a plurality of different metal oxides.

Furthermore, the present invention also uses the advantageous property of sol-gels of allowing inorganic particles of different crystalline phases to be synthesized in the same sol, for example by hydrothermal processing, or under more gentle conditions. In this chemistry, the particles are nucleated within the liquid medium. Having mixed colloidal sols consisting either of a mixture of metal oxide nanoparticles of different nature, or a mixture of metal oxide nanoparticles and metal nanoparticles and/or metal oxide nanoparticles doped with another metal oxide or with another metallic element also offers very many alternatives.

Moreover, thanks to the method of the invention, it is possible to further improve and refine the homogeneity and the stability of the sol by judiciously selecting the particle size distribution of the particles in the sol and the solvent used. This is because preferred conditions of implementing the method of the invention make it possible for segregations of nanoparticles, concentration gradients or sedimentations to be even further limited, or even prevented.

Furthermore, plasma spraying conditions and sol injection protocols allow the quality of the nanoparticle coating formed to be varied, and according to various examples presented hereinbelow, make it possible to further improve the quality and property retention of the particles of the colloidal sol within the coating material.

The definitions and the general preferred operating conditions of the method of the invention will be explained below.

According to the invention, the substrate may be an organic, inorganic or hybrid (mixed) substrate (that is to say one that is organic and inorganic on the same surface). Preferably, it withstands the operating conditions of the method of the invention. For example, it may consist of a material chosen from the following: semiconductors, such as silicon; organic polymers, such as polymethyl methacrylate (PMMA), polycarbonate (PC), polystyrene (PS), polypropylene (PP) and poly(vinyl chloride) (PVC); metals, such as gold, aluminium and silver; glasses; mineral oxides, for example in film form, such as SiO₂, Al₂O₃ , ZrO₂, TiO₂, Ta₂O₅, MgO, etc.; and composite or hybrid (mixed materials comprising several of these materials.

The surface of the substrate that it is desired to coat will optionally be cleaned so as to remove the organic and/or inorganic contaminants that might prevent deposition, or even attachment, of the coating on the surface and to improve the adhesion of the coating. The cleaning used depends on the nature of the substrate and may be chosen from physical, chemical or mechanical methods known to those skilled in the art. For example, but not limitingly, the cleaning method may be chosen from immersion in an organic solvent and/or cleaning using a detergent and/or acid pickling, these cleaning methods being ultrasonically assisted and possibly being followed by rinsing with town water and then rinsing with deionized water. These rinsings are optionally followed by a drying operation by lift-out, by an alcohol spray, by a compressed-air jet, hot air or by infrared radiation. The cleaning may also be cleaning using ultraviolet radiation.

The term “nanoparticles” is understood to mean particles of nanoscale size ranging generally from 1 nm to a few hundred nanometers. The term “particles” will also be used.

The term “sol-gel method” means a series of reactions in which soluble metallic species hydrolyze to form a metal hydroxide. The sol-gel method involves the hydrolysis/condensation of metal precursors (salts and/or alkoxydes) allowing particles to be easily stabilized and dispersed in a growth medium.

The term “sol” is understood to mean a colloidal system in which the dispersing medium is a liquid and the dispersed phase is a solid. The sol is also called a “colloidal sol-gel solution” or a “colloidal sol”. The nanoparticles are dispersed and stabilized thanks to the colloidal sol.

According to the invention, the sol may be prepared by any method known to those skilled in the art. Of course, methods that allow greater homogeneity of the nanoparticle size and greater stabilization and dispersion of the nanoparticles will be preferred. The methods of preparing the colloidal sol-gel solution described here include the various conventional methods of synthesizing nanoparticles dispersed and stabilized in a liquid medium.

According to a first variant of the present invention, the sol may be prepared for example by precipitation in an aqueous medium or by sol-gel synthesis in an organic medium from a nanoparticles precursor.

When the sol is prepared by precipitation in an aqueous medium from a nanoparticles precursor, the preparation may comprise, for example, the following steps:
step 1: hydrothermal synthesis of the nanoparticles from metal precursors using an autoclave or synthesis of the nanoparticles by coprecipitation at ordinary pressure;
step 2: treatment of the nanoparticles (powder), dispersion and stabilization of the nanoparticles in an aqueous medium (washings, dialyses);
step 3 (optional): dispersion of the nanoparticles in an organic medium so as to form an organic/inorganic hybrid sol by dispersing the particles within an organic polymer or oligomer and/or by functionalizing the surface of the particles by any type of reactive or unreactive organic functional groups.

Documents [8] and [9] and Example 2 below describe examples of this method of preparation by precipitation in an aqueous medium with various precursors (metalloid salts, metal salts, metal alkoxydes) which can be used for implementing the present invention.

When the sol is prepared by sol-gel synthesis in an organic medium from a nanoparticle precursor, the preparation may for example comprise the following succession of steps:
step (a): hydrolysis/condensation of organometallic precursors or metal salts in an organic or aqueous alcoholic medium;
step (b): nucleation of the stabilized and dispersed nanoparticles in an organic or aqueous alcoholic medium by ripening (ageing), growth; and
step (c) (optional): formation of an organic/inorganic hybrid sol by dispersing the particles within an organic polymer or oligomer and/or by functionalizing the surface of the particles by any type of reactive or unreactive organic functional groups.

Document [10] describes examples of this method of preparation by sol-gel synthesis in an organic medium, with various precursors (metalloid salts, metal salts, metal alkoxydes) which can be used within the present invention.

Thus, as explained above, the nanoparticles may be stabilized directly in the solvent used during the synthesis or subsequently peptized if they are synthesized by precipitation. In both cases, the suspension obtained is a sol.

Whatever the method of preparation chosen, according to the invention the nanoparticle precursors is typically chosen from the group comprising a metalloid salt, a metal salt, a metal alkoxyde or a mixture thereof. The aforementioned documents illustrate this technical aspect.

For example, the metal or metalloid of the salt or of the alkoxyde of the nanoparticles precursor may be chosen for example from the group comprising silicon, titanium, zirconium, hafnium, aluminium, tantalum, niobium, cerium, nickel, iron, zinc, chromium, magnesium, cobalt, vanadium, barium, strontium, tin, scandium, indium, lead, yttrium, tungsten, manganese, gold, silver, platinum, palladium, nickel, copper, cobalt, ruthenium, rhodium, europium and other rare earths, or a metal alkoxyde of these metals.

According to a second variant of the present invention, the sol may be prepared for example by synthesizing a solution of metal nanoparticles from a metal nanoparticles precursor using an organic or mineral reducing agent in solution, for example by a method chosen from the group comprising:
chemical reduction of organometallic or metallic precursors, or of metal oxides, for example in the manner described in document [11].

Whatever the method chosen in the second variant, according to the invention the reducing agent may be chosen for example from those mentioned in the aforementioned documents, for example from the group comprising polyols, hydrazine and its derivatives, quinone and its derivatives, hydrides, alkali metals, cysteine and its derivatives, and ascorbate and its derivatives.

Also according to the invention, the metal nanoparticles precursor may for example be chosen from those mentioned in the aforementioned documents, for example from the group comprising salts of metalloids or metals such as gold, silver, platinum, palladium, nickel, copper, cobalt, aluminium, ruthenium and rhodium, or the various metal alkoxydes of these metals.

According to a third variant of the present invention, the sol may be prepared by preparing a mixture of nanoparticles dispersed in a solvent, each family possibly resulting from preparations described in documents [8], [9], [10] and Example 2 given below.

Whatever the variant used to obtain the sol in the method of the invention, it is possible of course to use a mixture of various sols that differ by their chemical nature and/or by their method of formation.

Typically, the sol used in the method of the present invention may comprise, for example, nanoparticles of a metal oxide chosen from the group comprising SiO₂, ZrO₂, TiO₂, Ta₂O₅, HfO₂, ThO₂, SnO₂, VO₂, In₂O₃, CeO₂, ZnO, Nb₂O₅, V₂O₅, Al₂O₃, Sc₂O₃, Ce₂O₃, NiO, MgO, Y₂O₃, WO₃, BaTiO₃, Fe₂O₃, Fe₃O₄, Sr₂O₃, (PbZr)TiO₃, (BaSr)TiO₃, Co₂O₃, Cr₂O₃, Mn₂O₃, Mn₃O₄, Cr₃O₄, MnO₂, RuO₂ or a combination of these oxides, for example by doping the particles or by mixing the particles. This list is of course not exhaustive since it includes all the metal oxides described in the aforementioned documents.

Furthermore, according to the invention, the sol may for example comprise metal nanoparticles of a metal chosen from the group comprising gold, silver, platinum, palladium, nickel, ruthenium and rhodium, or a mixture of various metal nanoparticles consisting of these metals. Here again this list is not exhaustive since it includes all the metal oxides described in the aforementioned documents.

The size of the nanoparticles of the sol obtained is perfectly controlled by its synthesis conditions, in particular by the nature of the precursors used, the solvent or solvents, the pH, the temperature, etc. and may range from a few ångstroms to a few microns. The way in which the particle size is controlled in the preparation of the sols is described for example in document [12].

According to the invention, for example in the applications mentioned herein, the nanoparticles preferably have a size from 1 to 100 nm especially for the purpose of being able to produce thin films or coatings, for example with a thickness ranging from 0.1 to 50 μm.

Beside the nanoparticles, the sol also comprises a carrier liquid, which derives from its method of manufacture, called a “growth medium”. This carrier liquid is an organic or inorganic solvent such as those described in the aforementioned documents. For example, it may be a liquid chosen from water, alcohols, ethers, ketones, aromatics, alkanes, halogens and any mixture thereof. The pH of this carrier liquid depends on the method of producing the sol and on its chemical nature. It is generally from 1 to 14.

In the sols obtained, the nanoparticles are dispersed and stabilized within their growth medium, and this stabilization and/or dispersion may be favoured by the method of preparing the sol and by the chemistry used (see above). The method of the present invention benefits from this property of sols.

According to the invention, the sol may further include organic molecules. These may for example be molecules for stabilizing the nanoparticles in the sol and/or molecules that functionalize the nanoparticles.

Specifically, an organic compound may be added to the nanoparticles so as to give them a particular property. For example, stabilizing these nanoparticles in a liquid medium by a steric effect results in materials called Class I hybrid organic/inorganic materials. The interactions that govern the stabilization of these particles are weak and of an electrostatic nature of the hydrogen bond or van der Waals bond type. such compounds that can be used in the present invention, and their effect on the sols, are described for example in document [13] and in Example 2 below.

Again, according to the invention, the particles may be functionalized by an organic compound either during synthesis, by introducing suitable organomineral precursors, or by grafting onto the surface of the colloids. Examples were given above. These material are then called Class II organic/inorganic materials since the interactions between the organic component and the mineral particle are strong, of covalent or ionic-covalent nature. Such materials and methods of obtaining them are described in document [13].

The properties of the hybrid materials that can be used in the present invention depend not only on the chemical nature of the organic and inorganic components used to form the sol, but also on the synergy that may exist between these two chemistries. Document [13] describes the effects of the chemical nature of the organic and inorganic components used and such synergies.

The method of the invention comprises the injection of the colloidal sol into a thermal plasma jet or stream. The sol may be injected into the plasma jet by any suitable means of injecting a liquid, for example by means of an injector, for example in the form of a jet or of drops, preferably with suitable momentum so that it is substantially the same as that of the plasma stream. Examples of injectors will be given below.

The temperature of the sol during its injection may for example range from room temperature (20° C.) up to temperatures below its boiling point. Advantageously, the temperature of the sol may be controlled and modified for its injection, for example to be from 0° C. to 100° C. The sol then has a different surface tension depending on the imposed temperature, invoking a relatively rapid and effective fragmentation mechanism when the sol arrives in the plasma. The temperature may therefore have an effect on the quality of the coating obtained.

The injected sol, for example in the form of drops, penetrates the plasma jet, where it explodes into a multitude of droplets under the effect of the shear forces of the plasma. The size of these droplets may be adjusted, according to the desired microstructure of the coating, according to the properties of the sol (liquid) and of the plasma stream. Advantageously, the droplet size varies from 0.1 to 10 μm.

The kinetic and thermal energies of the plasma jet serve respectively to disperse the drops into a multitude of droplets (fragmentation) and then to vaporize the liquid. When the liquid sol reaches the core of the jet, which is a high-temperature high-velocity medium, it is vaporized and when the nanoparticles are accelerated before being received on the substrate, forming a nanostructured coating having a crystalline structure identical to that of the particles initially present in the starting sol. Vaporization of the liquid causes the fine nanoparticles of material forming part of one and the same droplet to come together and agglomerate. The resulting agglomerates, generally having a size of less than 1 μm, are in the core of the plasma where they are melted, partially or completely, then accelerated before being received on the substrate. If the agglomerates are completely melted, the size of the grains in the coating varies from a few hundred nanometers to a few microns. However, if the melting is only partial, the size of the grains in the coating is close to that of the particles contained in the starting liquid and the crystalline properties of the particles are well maintained within the coating.

Generally, thermal plasmas are plasmas producing a jet having a temperature ranging from 5000 K to 15 000 K. This temperature range is preferred when implementing the method of the invention. Of course, the temperature of the plasma used for spraying the sol onto the surface to be coated may be different. It will be chosen according to the chemical nature of the sol and of the desired coating. According to the invention, the temperature will be preferably chosen so as to ensure a configuration in which the sol particles are partially or completely melted, preferably partially melted, so as to best preserve their starting properties within the coating.

The plasma may for example be a transferred-arc or non-transferred-arc plasma, or an inductively coupled or radiofrequency plasma, for example in supersonic mode. It may operate at atmospheric pressure or at lower pressure. Documents [14], [15] and [16] describe plasmas that can be used in the present invention and the plasma torches for generating them. Advantageously, the plasma torch used is an arc-plasma torch.

According to the invention, the plasma-forming jet may advantageously be generated from a plasma gas chosen from the group comprising Ar, H₂, He and N₂. Advantageously, the plasma jet constituting the jet has a viscosity of 10⁻⁴ to 5×10⁻⁴ kg/m.s. Advantageously, the plasma jet is an arc-plasma jet.

The substrate to be coated is, for obvious reasons, preferably positioned relative to the plasma jet so that the nanoparticles are sprayed directly onto the surface to be coated. Various trials allows the optimum position to be very easily found. The positioning is adjusted for each application, depending on the spraying conditions selected and on the desired microstructure of the coating.

The high coating growth rate for a method of producing finely structured coatings essentially depends on the percentage of material by weight in the liquid and on the liquid flow rate. It is easily possible with the method of the invention to obtain a nanoparticle coating deposition rate of 1 to 100 μm/min.

The thin films or coatings that may be obtained by the method of the invention, ranging easily from 0.1 to 50 μm in thickness, may consist of grains having a size of the order of 1 micron or less. They may be dense or porous, and may be pure and homogeneous. By synthesizing a stable and homogenous sol-gel solution of nanoparticles of defined size combined with the liquid plasma spraying method of the invention, it is possible to retain the intrinsic properties of the starting sol within the coating and to obtain a nanostructured coating by advantageously controlling the following properties: porosity/density; composition homogeneity; “exotic” stoichiometry (with the aforementioned sols and mixtures); nanoscale structure (size and crystalline phases); grain size; thickness of the homogeneous coating on an object of complex shape; possibility of depositing on any type of substrate, irrespective of their nature and their roughness.

The method of the invention may be carried out several times on the same substrate surface, with different sols—differing in composition and/or in concentration and/or in particle size—in order to produce successive layers of different materials or else coatings with composition gradients. These coatings consisting of successive layers are useful for example in applications such as layers having electrical properties (electrode and electrolyte), layers having optical properties (low and high refractive indices), layers having a thermal property (conducting or insulating), diffusion barrier layers and/or controlled porosity layers.

The spraying method of the present invention can be easily carried out on an industrial scale since its specificity and its innovative character lie in particular in the injection system that can be fitted onto any thermal spraying machines already existing in the industry, in the nature of the sol-gel solution and in the choice of plasma conditions for obtaining a nanostructured coating having the properties of the sprayed particles.

The present invention also relates to a device for coating a surface of a substrate that can be used for implementing the method of the invention, said device comprising:
a thermal plasma torch capable of producing a plasma jet;
a container containing a plasma-forming gas;
a container containing a colloidal sol of nanoparticles;
a means for fixing and for positioning the substrate relative to the plasma torch;
an injection system connecting, on the one hand, the colloidal sol container and, on the other hand, an injector whose end is microperforated with a hole for injecting the colloidal sol into the plasma jet generated by the plasma torch; and
a pressure-reducing valve for adjusting the pressure inside the container.

Advantageously, the plasma torch is capable of producing a plasma jet having a temperature ranging from 5000 K to 15000 K. Advantageously, the plasma torch is capable of producing a plasma jet having a viscosity ranging from 10⁻⁴ to 5×10⁻⁴ kg/m.s. Advantageously, the plasma-forming torch is an arc-plasma torch. Examples of plasma gases were given above, and containers of these gases are commercially available. The reasons for these advantageous choices are explained above.

Advantageously, the device of the invention comprises several containers, respectively containing several sols laden with nanoparticles, the sols differing from one another by their composition and/or diameter and/or concentration. The device of the invention may further include a cleaning container, which contains a solution for cleaning the pipework and the injector. Thus, the pipework and the injector may be cleaned between each time the method is implemented.

The containers may be connected to a compressed-air line via pipes and to a pressurized gas supply, for example compressed air. One or more pressure-reducing valves allow the pressure inside the container(s) to be adjusted, generally to a pressure below 2×10⁶ Pa (20 bar). In this case, under the effect of the pressure, the liquid is conveyed to the injector, or to the injectors if there are several of the, via pipes and is then expelled from the injector, for example in the form of a liquid jet that is mechanically fragmented into coarse drops, preferably of calibrated diameter, on average twice as large as the diameter of each circular outlet hole. A pump can also be used. The flow rate and the momentum of the sol output by the injector depend in particular:
on the pressure in the container used and/or of the pump;
on the characteristics of the dimensions of the outlet orifice (“depth diameter”);
on the theological properties of the sol.

The injector is used to inject the sol into the plasma. It is preferably such that the injected sol is mechanically fragmented on exiting the injector into drops as indicated above. According to the invention, the hole of the injector may be of any shape allowing the colloidal sol to be injected into the plasma jet, preferably under the aforementioned conditions. Advantageously, the hole of the injector is circular and has a diameter ranging from 10 to 500 μm. According to the invention, the system may be provided with several injectors, for example depending on the quantities of sol to be injected.

According to one particular embodiment of the system of the invention, the angle at which the injector is angled to the longitudinal axis of the plasma jet may vary from 20° to 160°. also advantageously, the injector may be moved along the longitudinal direction of the plasma jet. These movements are indicated schematically in appended FIG. 2. Thus, the injection of the colloidal sol into the plasma jet may be oriented. This orientation makes it possible to optimize the injection of the colloidal sol and therefore the formation of the coating sprayed onto the surface of the substrate.

According to the invention, the sol injection line may be thermostatted so as to control and possibly modify the temperature of the injected sol. This control of the temperature and this modification may be accomplished within the pipes and/or within the containers.

According to the invention, the device may include a means for fixing and for positioning the substrate relative to the plasma torch. This means may consist of clamps or an equivalent device allowing the substrate to be gripped (fixed) and held in place during the plasma spraying in a chosen position, and of a means for moving the surface of the substrate facing the plasma jet rotationally and translationally and also in the longitudinal direction of the plasma jet. Thus, the position of the surface to be coated relative to the plasma jet may be optimized in order to obtain a homogeneous coating.

The invention makes it possible, thanks to a well-suited injection device, for example using the system of the invention, to directly inject a stable suspension of nanoparticles of “sol” solution, since it results from synthesizing a colloid by a sol-gel method involving the hydrolysis/condensation of metal precursors (salts of alkoxydes) allowing particles to be easily stabilized and dispersed within their growth medium.

The main advantages of the present invention compared with the methods of the prior art are:
preservation of the particle size and particle size distribution of the nanoparticles;
preservation of the crystalline state of the sprayed material;
preservation of the initial stoichiometry and of the state of homogeneity;
control of the film porosity;
deposition of coatings with submicron thicknesses without any difficulty, unlike with the conventional thermal spraying method of the prior art;
excellent and unusually high thermal spraying efficiency in terms of weight, by limiting losses of material, that is to say a mass deposited/mass sprayed ratio, of greater than 80% by weight;
lower temperatures to which the sprayed materials are subjected, thus permitting the use of thermally sensitive compositions;
possibility, hitherto unprecedented, of depositing coatings on supports of any nature and of any roughness, such as on glass or mirror-polished silicon wafers (in the latter case, very low surface roughness of substrates would prevent adhesion of the coatings);
capability of thermally spraying coatings having an SiO₂ composition, which composition hitherto was not achievable using conventional methods; and
production of mechanically resistant and adherent coatings.

The present invention is applicable in all technical fields in which it is necessary to obtain a nanostructured coating, as it allows the production of such a coating with excellent quality in terms of fineness, homogeneity, thickness and particle size. As non-exhaustive examples, the present invention may be used in the following applications:
the coating of metals and oxides in order to render them corrosion-resistant. To do this, a colloidal sol such as those described in document [8] may for example be used to implement the method of the invention;
the deposition of abrasion-resistant composite coatings. To do this, a colloidal sol such as those described in documents [8], [9], [10] and Example 2 below may for example be used to implement the method of the invention;
the deposition of coatings resistant to high temperature, such as coatings of refractory materials and composite coatings. To do this, a colloidal sol such as those described in documents [8], [9], [10] and Example 2 below may for example be used to implement the method of the invention;
the deposition of coatings that are involved in interactions between surfaces undergoing relative movement (tribology), such as abrasion-resistant composite coatings and/or lubricants. To do this, a colloidal sol such as those described in document [10] may for example be used to implement the method of the invention;
the deposition of coatings that are employed in the conversion and storage of energy, such as:
   coatings used in the photothermal conversion of solar energy. To do this, a colloidal sol such as those described in Example 2 below may for example be used to implement the method of the invention and
   coatings in the form of stacks of active materials, for example, a solid-oxide fuel cell, for electrochemical generators, for example lead batteries, lithium-ion batteries, supercapacitors, etc. To do this, a colloidal sol such as those described in documents [8] and [17] may for example be used to implement the method of the invention;
coatings involved in catalysis reactions, for example for the production of supported catalysts for gas pollution control, for combustion or for synthesis. To do this, a colloidal sol such as those described in document [8] and Example 2 below may for example be used to implement the method of the invention;
the deposition of coatings that act as chemical or biological microreactors. To do this, a colloidal sol such as those described in document [10] may for example be used to implement the method of the invention; and
the deposition of coatings on microelectromechanical systems (MOEMS), for example in the automotive, telecommunication, astronomy and avionics fields, and in biological and medical analysers.

The present invention therefore also relates to an optical and/or electronic device comprising a nanostructured coating obtainable by the method of the invention, that is to say one having the physical and chemical characteristics of the coatings obtained by the method of the invention.

The present invention therefore also relates to a fuel cell comprising a nanostructured coating that can be obtained by the method of the invention, that is to say one having the physical and chemical characteristics of the coatings obtained by the method of the invention.

The present invention therefore also relates to a thermal barrier comprising a coating that can be obtained by the method of the invention, that is to say one having the physical and chemical characteristics of the coatings obtained by the method of the invention.

Other features and advantages of the invention will become apparent on reading the following examples given purely by way of illustration and implying on limitation, with reference to the appended drawings.

### BRIEF DESCRIPTION OF THE DRAWINGS

FIG. 1 shows a simplified diagram of part of the device for implementing the method of the invention, allowing the colloidal sol of nanoparticles to be injected into a plasma jet.

FIG. 2 shows a simplified diagram of a way of injecting the colloidal sol of nanoparticles into a plasma jet with a schematic representation of the plasma torch.

FIG. 3 shows an X-ray powder diffraction diagram of a zirconia.

FIG. 4 shows two micrographs obtained by transmission electron microscopy on a zirconia sol.

FIG. 5 is a graph comparing by X-ray diffraction the crystalline structure of a coating deposited by the method of the present invention with that of the initial sol of ZrO₂ nanoparticles.

FIGS. 6a and 6b show micrographs taken in transmission electron microscope of the zirconia coating: a) at the surface of the zirconia coating; and b) in cross section.

### EXAMPLES

### Example 1

### Method of the Invention and Coating Obtained from a Zirconia Sol

An aqueous 10% zirconia (ZrO₂) sol was injected into an argon/hydrogen (75 vol % Ar) transferred (blown)-arc plasma.

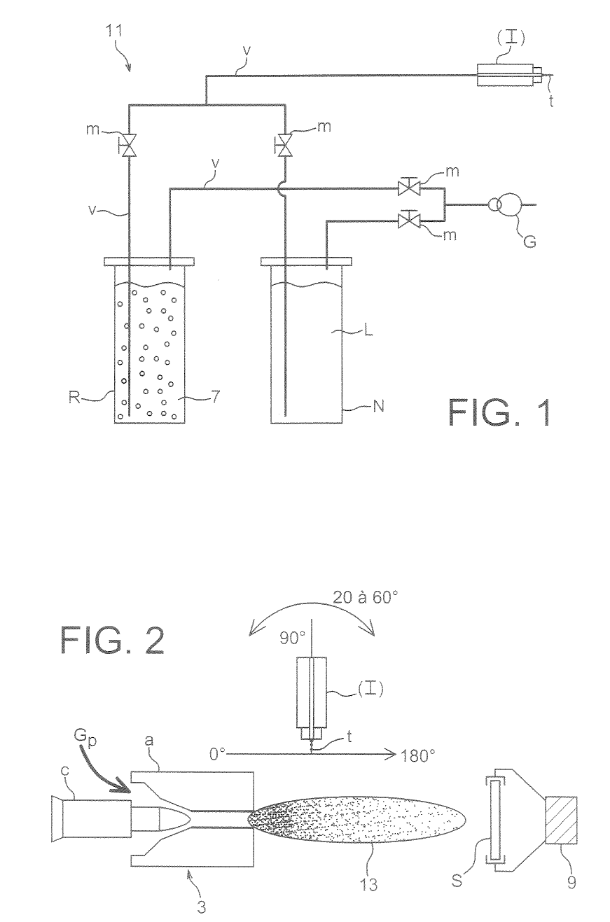

The experimental set-up used for producing the nanostructured zirconia coatings is shown in FIGS. 1 and 2. It consisted of:
a Sulzer-Metco F4 VB (trade mark) DC plasma torch (3) fitted with an anode of 6 mm inside diameter;
the device for injecting the liquid, described in FIG. 1; and
a device (9) for fixing and for moving the substrate to be coated relative to the torch at a given distance (FIG. 2).

With regard to the injection device, this comprised a container (R) containing the colloidal sol (7) and a cleaning container (N) containing a cleaning liquid (L) for cleaning the injector and the pipework (v). It also included pipes (v) for conveying the liquids from the containers to the injector (I), pressure-reducing valves (m) for adjusting the pressure in the containers (pressure>2×10⁶ Pa). The assembly was connected to a compression gas (G), here air, allowing a compressed-air supply to be created in the pipes. Under the effect of the pressure, the liquid was conveyed to the injector.

As regards the liquid injection, the diameter of the outlet orifice (t) of the injector (I) was 150 μm and the pressure in the container (R) containing the sol was 0.4 MPa. This implied a liquid flow rate of 20 ml/min and a speed of 16 m/s. The sol was expelled from the injector in the form of a liquid jet that fragmented mechanically into the form of coarse drops having a calibrated diameter ranging from 2 μm to 1 mm, on average twice as large as the diameter of the circular outlet hole. The injector (FIG. 2) could be inclined to the axis of the plasma jet at an angle ranging from 20 to 160°. In the trials, the angle of inclination used was 90°.

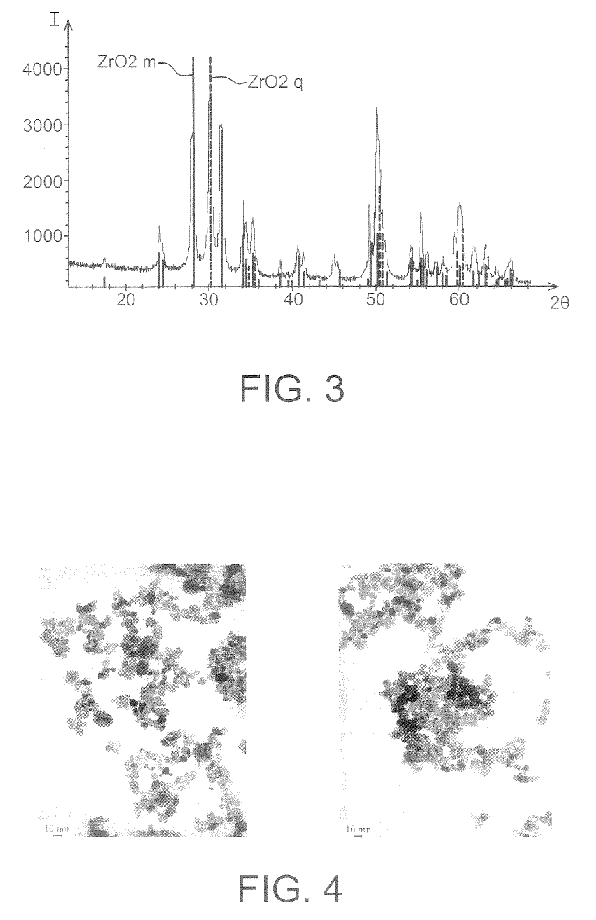

The initial sol was obtained according to the method described in document [8]. In this sol, the zirconia particles were crystallized in two phases, one monoclinic (m.ZrO₂) and the other, less significant tetragonal (t.ZrO₂) as the X-ray diffraction diagram given in FIG. 3 shows (I=intensity).

The mean diameter of the crystallites, observed in TEM (transmission electron microscopy) was about 9 nm as the micrographs in FIG. 4 show (see Example 2 below).

The zirconia coatings obtained from plasma spraying were obtained at 70 mm from the intersection between the liquid jet and the plasma jet. Various types of substrates to be coated were tested: aluminium wafers, silicon wafers and glass plates.

The deposition rate was 0.3 μm for each pass of the torch in front of the substrate.

Depending on the spray time, the thickness of the coatings obtained were between 4 μm and 100 μm.

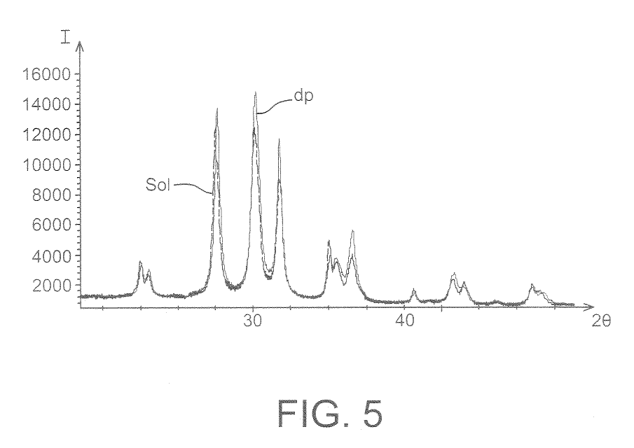

FIG. 5 is a graph comparing by X-ray diffraction (I=intensity) the crystalline structure of a coating deposited by the method of the present invention (dep) and of the initial sol of ZrO₂ nanoparticles (sol).

Usually in plasma spraying, the zirconia sprayed is in the tetragonal form in the coating, with a small amount of monoclinic corresponding to unmelted or partially melted particles, whatever the initial phase. Here, the structure and the proportion of the crystalline phases present in the coating were practically the same as those of the initial sol:
61% monoclinic and 39% tetragonal initially; and
65% monoclinic and 35% tetragonal in the coating obtained.

The size of the crystals in the coating was between 10 and 20 nm, and was very close to that of the particles of the initial sol.

The TEM observations of the interface between the silicon substrate and the coating (cross section) showed good adhesion of the zirconia particles to the mirror-polished surface.

Furthermore, the surface finish of the substrate had no effect on the adhesion of the plasma coating.

### Example 2

The zirconia sol of Example 1, having specific (dispersion and stabilization) properties of the present invention, was sprayed in a plasma jet as described in Example 1.

This zirconia sol consisted of nanoparticles crystallized in monoclinic phase and in tetragonal phase. The size distribution was obtained from TEM micrographs of the zirconia sol. The mean diameter of the zirconia particles was 9 nm. The micrograph on the right in appended FIG. 4 is a TEM micrograph taken on this zirconia sol used. The bar at the bottom left indicates the scale of the micrograph, here representing 10 nm in the micrograph.

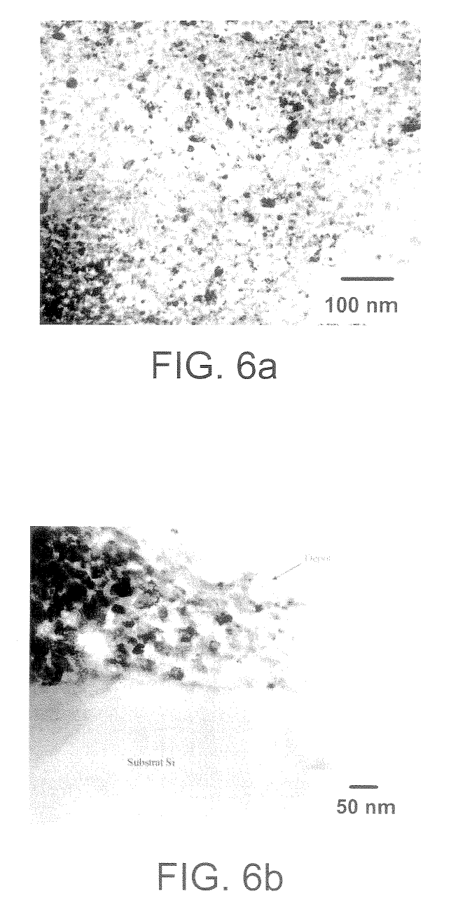

The coating produced by plasma spraying said sol according to the method of the invention consisted, using TEM surface and thickness analysis, of zirconia nanoparticles having a morphology similar to those of the initial sol and with a mean diameter of 10 nm. These measurements can be deduced from the appended FIGS. 6a and 6b. The bar at the bottom right of these micrographs indicates the scale of the micrograph, here 100 nm in the upper micrograph (FIG. 6a) and 50 nm in the lower micrograph (FIG. 6b).

The particles sprayed by the method of the present invention were therefore not chemically modified.

X-ray diffraction analysis of the initial zirconia sol particles (sol) (broken line) was compared with that of the coating obtained by plasma spraying the same zirconia sol (dep) (continuous line). This analysis is shown in appended FIG. 5 (y-axis: intensity; x-axis: 2θ). The crystallite size and the distribution of the crystalline phases were determined by resolving the X-ray diagrams using the Rietveld method.

The zirconia sol as the zirconia coating obtained from this sol had crystallites of the same diameter and were crystallized in the same two, monoclinic and tetragonal, phases. The table below gives the distribution in % of these crystalline phases present in the zirconia sol and the zirconia coating, and also their size.

| | Distribution of the | | | |
|---|---|---|---|---|
| | crystalline phases | | Crystallite sizes | |
| Materials | Monoclinic | Tetragonal | Monoclinic | Tetragonal |
| ZrO₂ Sol | 65% | 35% | 11.8 nm | 8.9 nm |
| ZrO₂ | 61% | 39% | 12 nm | 8.9 nm |
| coating | | | | |

These results clearly show that the size and the proportion of nanoparticles crystallized in the monoclinic phase and in the tetragonal phase are typically the same in the initial sol and the sprayed coating. This innovative specific feature in which the intrinsic properties of the sol are maintained in the plasma coating is the result of using, according to the method of the present invention, a dispersed and stabilized colloidal suspension that does not change during thermal spraying.

### Example 3

### Preparation of a Nanoparticle Sol

This example illustrates one of many ways of preparing a nanoparticle sol that can be used for implementing the present invention.

A colloidal solution of titanium oxide TiO₂ was prepared by adding, drop by drop, a titanium tetraisopropoxide solution (0.5 g) dissolved in 7.85 g of isopropanol to 100 ml of a dilute hydrochloric acid solution (pH=1.5) with vigorous stirring. The mixture obtained was kept magnetically stirred for 12 hours.

Transmission electron microscopy observations showed a mean diameter of the colloids of about 10 nm. The X-ray diagram was characteristic of that of titanium oxide in anatase form.

The pH of this sol was about 2 and the mass concentration of TiO₂ was brought to 10% by distillation (100° C./10⁵ Pa).

Before being used in the method of the invention, the colloidal nanoparticle solution could be filtered, for example to 0.45 μm.

### LITERATURE REFERENCES

[1] U.S. Pat. No. 5,032,568, Lau et al, 1991.
[2] U.S. Pat. No. 4,982,067, Marantz et al, 1991.
[3] U.S. Pat. No. 5,413,821, Ellis et al, 1995.
[4] U.S. Pat. No. 5,609,921, Gitzhofer et al, 1997.
[5] U.S. Pat. No. 6,447,848, Chow et al, 2002.
[6] WO-A-97/18341, Kear et al, 1997.
[7] N. P. Rao, H. J. Lee, D. J. Hansen, J. V. R. Heberlein, P. H. McMurry and S. L. Girshick, “Nanostructured Materials production by Hypersonic Plasma Particle Deposition”, Nanostructured Materials, 1997, 9, pp. 129-132.
[8] FR-A-2 707 763 (CEA), H. Floch and P. Belleville, “Matériau composite á indice de réfraction élevé, procédé de fabrication de ce matériau composite et matériau optiquement actif comprenant ce matériau composite [High-refractive-index composite material, process for manufacturing this composite material, and optically active material comprising this composite material]”.
[9] FR-A-2 682 486 (CEA), H. Floch and M. Berger, “Miroir diélectrique interférentail et procédé de fabrication d'un tel miroir [Interference dielectric mirror and process for manufacturing such a mirror]”.
[10] FR-A-2 703 791 (CEA), P. Belleville and H. Floch, “Procédé de fabrication de couches minces preésentant des propriétés optiques et de résistance á l'abrasion [Process for manufacturing thin films having optical and abrasion resistance properties]”.
[11] F. Fievet, Polyol process. Fine particles: Synthesis, Characterization and Mechanisms of Growth, 2000, 92: pp. 460-496.
[12] W. Stoöber, A. Fink and E. Bohn, Journal of Colloid and Interface Science, 26, 1968, pp. 62-69.
[13] “Functional Hybrid Materials”, P. Gomez-Romero and C. Sanchez, Wiley-VCH Publishers, 2004.
[14]“Plasmas thermiques: Production et applications [Thermal plasma: Production and Applications]”, P. Fauchais, Techniques de l'ingénieur, Traite Génie Électrique [Electrical Engineering Treaty], D2820-1 to D2820-25.
[15] “Characterizations of LPPS processes under various spray conditions for potential applications”, A. Refke, G. Barbezat, J L. Dorier, M. Gindrat and C. Hollenstein, Proc Of International Thermal Spray, Conference 2003, Orlando, Fla., USA, 5-8 May 2003.
[16] “New applications and new product qualities by radiofrequency plasma spraying”, R. Henne, V. Borck, M. Müller, R. Ruckdäsch and G. Schiller, Proc. Of Tagunsband Proceedings, United Thermal Spray Conference, Düseldorf, 17-19 Mar. 1999.
[17] S. Somiya, M. Yoshimura, Z. Nakai, K. Hishinuma and T. Kumati, “Hydrothermal processing of ultrafine single crystal zirconia and hafnia powders with homogenous dopants”, Advances in ceramics, 21, 1987, pp. 43-55.

1. A method of coating a surface of a substrate with nanoparticles, wherein said method comprises injecting a colloidal sol of said nanoparticles, into a thermal plasma jet that sprays the colloidal sol of said nanoparticles onto said surface.

2. The method according to claim 1, in which the nanoparticles are dispersed and stabilized in the colloidal gel.

3. The method according to claim 1, in which the nanoparticles have a size from 1 to 100 nm.

4. The method according to claim 1, in which the sol is prepared by precipitation in an aqueous medium or by sol-gel synthesis in an organic medium from a nanoparticles precursor.

5. The method according to claim 4, in which the nanoparticles precursor is chosen from the group comprising a metalloid salt, a metal salt, a metal alkoxide, or a mixture thereof.

6. The method according to claim 5, in which the metal or metalloid of the salt or of the alkoxide of the nanoparticles precursor is chosen from the group comprising silicon, titanium, zirconium, hafnium, aluminum, tantalum, niobium, cerium, nickel, iron, zinc, chromium, magnesium, cobalt, vanadium, barium, strontium, tin, scandium, indium, lead, yttrium, tungsten, manganese, gold, silver, platinum, palladium, nickel, copper, cobalt, ruthenium, rhodium, europium and other rare earths, or a metal alkoxide of these metals.

7. The method according to claim 1, in which the sol is prepared by synthesizing a solution of metal nanoparticles from a metal nanoparticles precursor using an organic or mineral reducing agent in solution, by a method chosen from the group comprising a reduction of metal slats in an emulsion medium and chemical reduction of organometallic or metallic precursors or of metal oxides.

8. The method according to claim 7, in which the reducing agent is chosen from the group comprising polyols, hydrazine and its derivatives, quinone and its derivatives, hydrides, alkali metals, cysteine and its derivatives, and ascorbate and its derivatives.

9. The method according to claim 7, in which the metal nanoparticles precursor is chosen from the group comprising salts of metalloids or metals such as gold, silver, platinum, palladium, nickel, copper, cobalt, aluminum, ruthenium and rhodium, or the various metal alkoxides of these metals.

10. The method according to claim 1, in which the sol is a mixed sol.

11. The method according to claim 1, in which the sol comprises nanoparticles of a metal oxide chosen from the group comprising SiO₂, ZrO₂, TiO₂, Ta₂O₅, HfO₂, ThO₂, SnO₂, VO₂, In₂O₃, CeO₂, ZnO, Nb₂O₅, V₂O₅, Al₂O₃, Sc₂O₃, Ce₂O₃, NiO, MgO, Y₂O₃, WO₃, BaTiO₃, Fe₂O₃, Fe₃O₄, Sr₂O₃, (PbZr)TiO₃, (BaSr)TiO₃, Co₂O₃, Cr₂O₃, Mn₂O₃, Mn₃O₄, Cr₃O₄, MnO₂, RuO₂ or a combination of these oxides by doping the particles or by mixing.

12. The method according to claim 11, in which the sol further includes metal nanoparticles of a metal chosen from the group comprising gold, silver, platinum, palladium, nickel, ruthenium and rhodium, or a mixture of various metal nanoparticles consisting of these metals.

13. The method according to claim 1, in which the sol further includes organic molecules.

14. The method according to claim 13, in which the organic molecules are molecules for stabilizing the nanoparticles in the sol and/or molecules that functionalize the nanoparticles.

15. The method according to claim 1, in which the colloidal sol is injected into the plasma jet in the form of drops.

16. The method according to claim 1, in which the plasma jet is an arc-plasma jet.

17. The method according to claim 1, in which the plasma jet is such that it causes partial melting of the injected nanoparticles.

18. The method according to claim 1, in which the plasma constituting the jet has a temperature ranging from 5000 K to 15000 K.

19. The method according to claim 1, in which the plasma constituting the jet has a viscosity ranging from 10⁻⁴ to 5×10⁻⁴ kg/m.s.

20. The method according to claim 1, in which the plasma jet is generated from a plasma-forming gas chosen from the group consisting Ar, H₂, He and N₂.

21. A nanostructured coating obtainable by a method according to claim 1.

22. The nanostructured coating according to claim 21 having a thickness ranging from 0.1 to 50 μm.

23. The nanostructured coating according to claim 21, consisting of grains with a size of less than or of the order of 1 micron.

24. A substrate having at least one surface coated with the nanostructured coating according to claim 21.

25. The substrate according to claim 24, said substrate consisting of an organic, inorganic or hybrid material.

26. A device comprising the nanostructured coating according to claim 21.

27. A fuel cell comprising the nanostructured coating according to claim 21.

28. A thermal barrier comprising the nanostructured coating according to claim 21.

29. A device for implementing the method of claim 1, said device comprising:
a thermal plasma torch capable of producing a plasma jet;
a container containing a plasma-forming gas;
a container containing a colloidal sol of dispersed stabilized nanoparticles;
a means for fixing and for positioning the substrate relative to the plasma torch;
an injection system connecting the colloidal sol container and, an injector whose end is microperforated with a hole for injecting the colloidal sol into the plasma jet generated by the plasma torch; and
a pressure-reducing valve for adjusting the pressure inside the container.

30. The device according to claim 29, in which the plasma torch is an arc-plasma torch.

31. The device according to claim 29, in which the plasma torch is capable of producing a plasma jet having a temperature ranging from 5000 K to 15000 K.

32. The device according to claim 29, in which the plasma torch is capable of producing a plasma jet having a viscosity ranging from 10⁻⁴ to 5×10⁻⁴ kg/m.s.

33. The device according to claim 29, in which the inclination of the injector to the longitudinal axis of the plasma jet may vary from 20 to 160°.

34. The device according to claim 29, in which the injector makes it possible to form drops of the colloidal sol, which drops into the plasma jet when the plasma torch is actuated.

35. The device according to claim 29, in which the hole of the injector is circular.

36. The device according to claim 29, in which the hole of the injector has a diameter ranging from 10 to 500 μm.

37. The device according to claim 29, in which the plasma-forming gas is chosen from the group comprising Ar, H₂, He and N₂.

38. The device according to claim 29, which further includes a container containing a cleaning solution, said container being connected via an injection system to the injector.

39. The device according to claim 26, wherein said device is an optical device.

40. The device according to claim 26, wherein said device is an electronic device.

41. A device comprising the substrate according to claim 24.

42. The device according to claim 41, wherein said device is an optical device.

43. The device according to claim 41, wherein said device is an electronic device.

44. A fuel cell comprising the substrate according to claim 24.

45. A thermal barrier comprising the substrate according to claim 24.
